(19) United States
(12) Patent Application Publication
(10) Pub. No.: US 2017/0082122 A1
(43) Pub. Date: Mar. 23, 2017

(54) Control Valve Compensation System

(71) Applicant: Rost Innovation LLC, Park Rapids, MN (US)

(72) Inventor: Alvin Stanley Rost, Park Rapids, MN (US)

(21) Appl. No.: 15/268,777

(22) Filed: Sep. 19, 2016

Related U.S. Application Data
(60) Provisional application No. 62/220,350, filed on Sep. 18, 2015.

(51) Int. Cl. F15B 13/04; F15B 13/00

(52) U.S. Cl. CPC F15B 13/0418; F15B 13/00; F15B 2013/002

(57) ABSTRACT

A Control Valve Compensation System for producing both a pre-compensated and a post-compensated load sensing hydraulic directional control valve module, wherein both configurations use the same components except for a sliding compensating component. The Control Valve Compensation System generally includes a hydraulic directional control valve housing which is adapted to be easily-interchangeable between a load sensing pre-compensated pressure configuration and a load sensing post-compensated pressure configuration by simply removing and replacing a different compensator assembly within the housing. The compensator assembly is adapted to direct oil flow through the housing while simultaneously providing compensation for the valve function. Directional valve assemblies may be provided, with the valve assemblies functioning to provide post-compensated functions, pre-compensated functions, and mixed pre- and post-compensated functions. These directional valve functions can be re-configured in the field by simply swapping the compensator assemblies to produce the desired functionality of the end-user at that particular time.

### CROSS REFERENCE TO RELATED APPLICATIONS

I hereby claim benefit under Title 35, United States Code, Section 119(e) of U.S. provisional patent application Ser. No. 62/220,350 filed Sep. 18, 2015. The 62/220,350 application is currently pending. The 62/220,350 application is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to a Control Valve Compensation System for producing both a pre-compensated and a post-compensated load sensing hydraulic directional control valve module, wherein both configurations use the same components except for a sliding compensating component.

Related Art

Any discussion of the related art throughout the specification should in no way be considered as an admission that such related art is widely known or forms part of common general knowledge in the field.

Control valves are widely used throughout a variety of industries. Hydraulic directional control valves are generally constructed to comprise either a pre-compensated configuration or a post-compensated configuration. In a pre-compensated configuration, module priority is provided by the control valve. In a post-compensated configuration, multiple modules are utilized to share the pump flow proportionally. Other desired functionality is accomplished by adding control components or logic controls adapted to control the sliding main component of the module.

Because of the inherent problems with the related art, there is a need for a new and improved Control Valve Compensation System for producing both a pre-compensated and a post-compensated load sensing hydraulic directional control valve module, wherein both configurations use the same components except for a sliding compensating component.

### SUMMARY

An example embodiment of the present invention is directed to a Control Valve Compensation System for producing both a pre-compensated and a post-compensated load sensing hydraulic directional control valve module, wherein both configurations use the same components except for a sliding compensating component. Such configurations allow manufacturers of such valves to reduce costs, such as manufacturing tooling costs and manufacturing testing costs. The present invention also aids with increasing inventory turn numbers. Each of the control valve systems disclosed herein are adapted to covert from pre-compensated to post-compensated, or vice versa, by simply changing a sliding compensating component.

There has thus been outlined, rather broadly, some of the features of the Control Valve Compensation System in order that the detailed description thereof may be better understood, and in order that the present contribution to the art may be better appreciated. There are additional features of the Control Valve Compensation System that will be described hereinafter and that will form the subject matter of the claims appended hereto. In this respect, before explaining at least one embodiment of the Control Valve Compensation System in detail, it is to be understood that the Control Valve Compensation System is not limited in its application to the details of construction or to the arrangements of the components set forth in the following description or illustrated in the drawings. The Control Valve Compensation System is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a sectional view of a first embodiment of a pre-compensated configuration of the present invention.

FIG. 2 is a sectional view of a first embodiment of a post-compensated configuration of the present invention.

FIG. 3 is a sectional view of a first embodiment of a pre-compensated configuration of the present invention in a working position.

FIG. 4 is a sectional view of a first embodiment of a post-compensated configuration of the present invention in a working position.

FIG. 5 is a sectional view of a second embodiment of a pre-compensated configuration of the present invention.

FIG. 6 is a sectional view of a second embodiment of a post-compensated configuration of the present invention.

### DETAILED DESCRIPTION

### Overview.

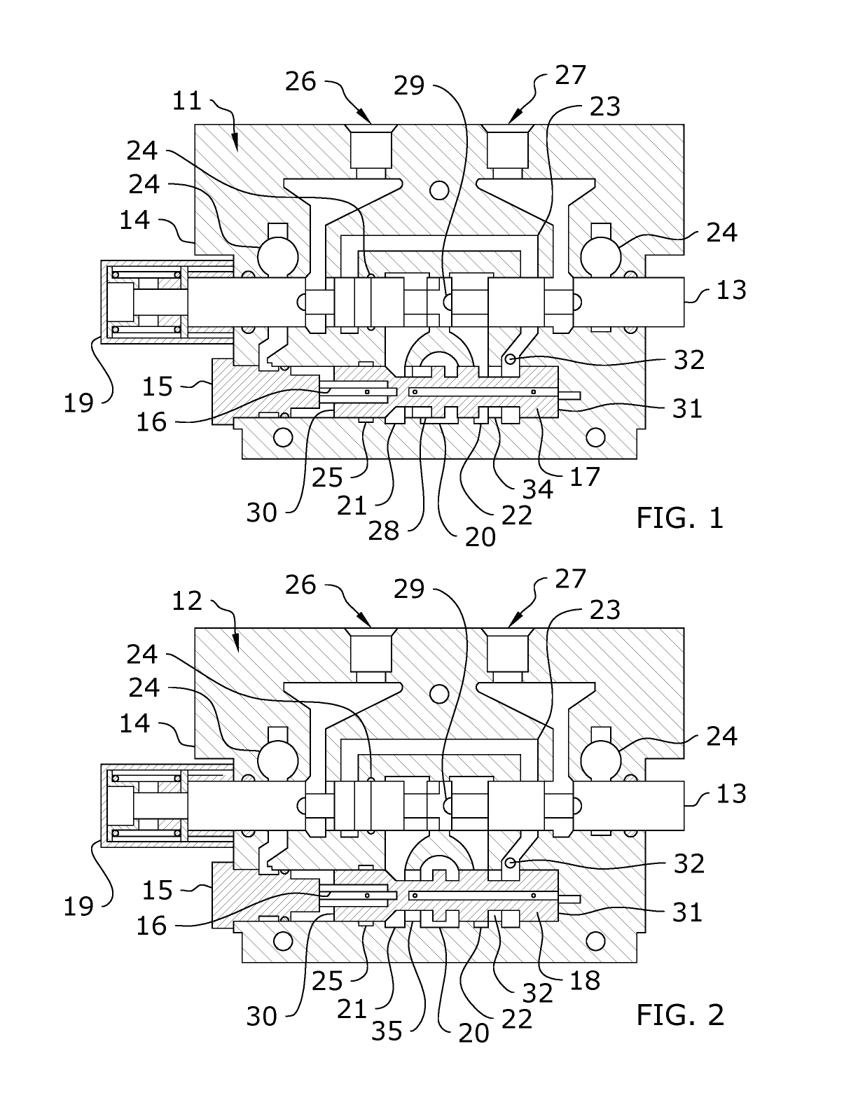

Turning now descriptively to the drawings, in which similar reference characters denote similar elements throughout the several views, FIGS. 1 through 6 illustrate a Control Valve Compensation System 10, which comprises a hydraulic directional control valve housing 11, 12 which is adapted to be easily-interchangeable between a load sensing pre-compensated pressure configuration 11 and a load sensing post-compensated pressure configuration 12 by simply removing and replacing a different compensator assembly within the housing. The compensator assembly is adapted to direct oil flow through the housing 11, 12 while simultaneously providing compensation for the valve function. Directional valve assemblies may be provided, with the valve assemblies functioning to provide post-compensated functions, pre-compensated functions, and mixed pre-and post-compensated functions. These directional valve functions can be re-configured in the field by simply swapping the compensator assemblies to produce the desired functionality of the end-user at that particular time.

### B. Pre-Compensated Configuration.

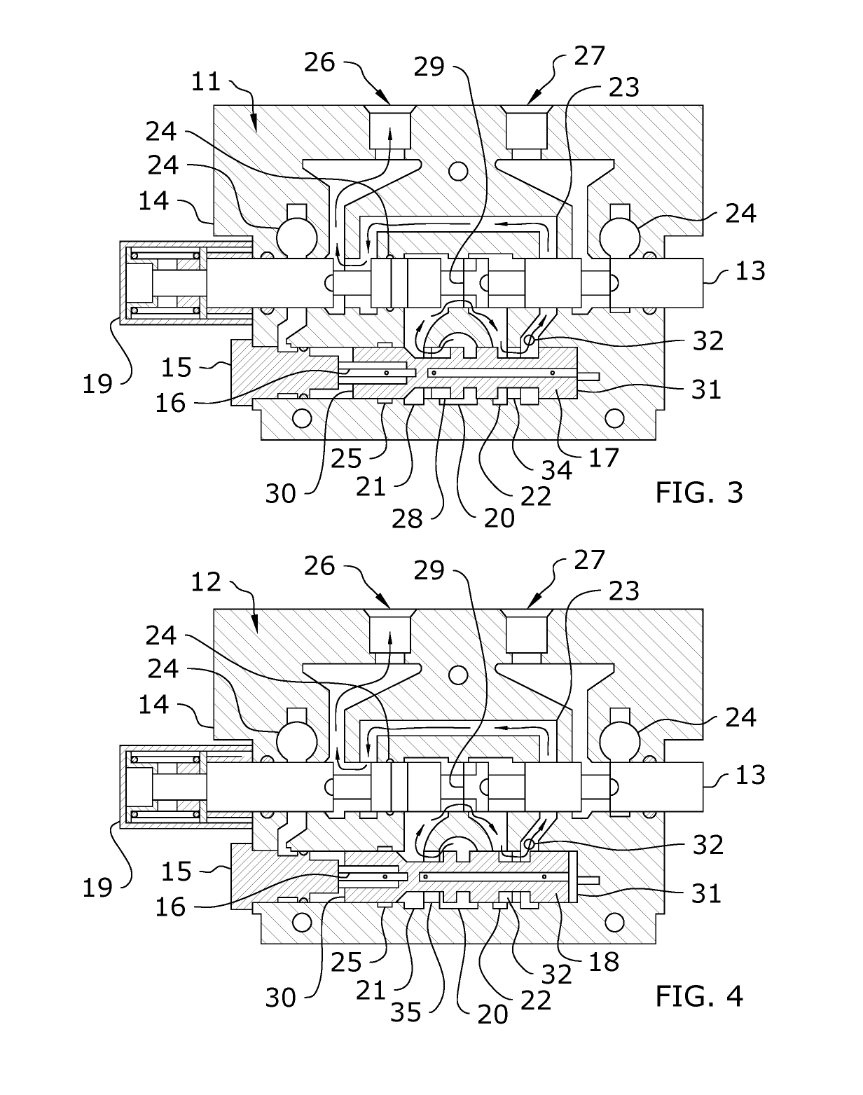

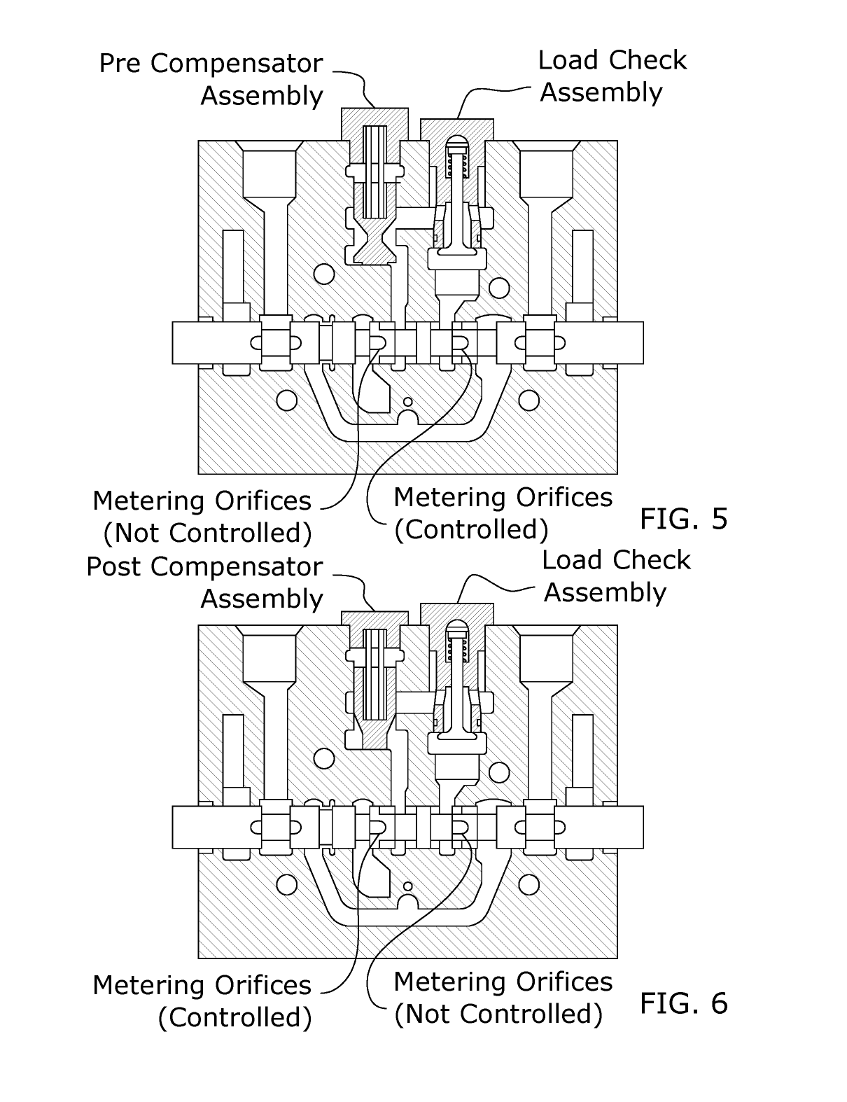

FIGS. 1, 3, and 5 illustrate different embodiments of the present invention configured for pre-compensation. FIG. 1 illustrates the pre-compensation configuration. FIG. 3 illustrates the pre-compensation configuration in a work position. FIG. 5 illustrates an alternate embodiment of the pre-compensation configuration in which the compensator is positioned perpendicular with respect to the main control unit.

As shown in FIGS. 1 and 3, the pre-compensated configuration 11 comprises a valve body 14 with a plurality of internal flow passageways 20, 21, 22, 23, 24, 26, 27. It should be noted that the number, configuration, orientation, and types of passageways 20, 21, 22, 23, 24, 26, 27 utilized may vary in different embodiments of the present invention. In the exemplary embodiment shown in the figures, these include a power passageway 20, a first intermediate passageway 21, a second intermediate passageway 22, a loop passage 23, one or more return passages 24, and a plurality of work ports 26, 27.

The pre-compensated configuration 11 further comprises a selectable valve spool 13. Various types of spools may be utilized, and the types of spools shown in the figures should not be construed as limiting on the scope of the present invention. The selectable valve spool 13 may include a plurality of control notches 29. A pre-compensator piston 17 is provided which may include a compensating aperture 28. The spring 16 shown in the figures is generally biased to be normally open in the pre-compensated configuration 11.

When the selectable valve spool 13 is positioned toward a first side of the housing 11 (i.e. to the right side as shown in the figures), fluid will flow from the power passage 20 across the compensator piston 17 and notches 28 into the first intermediate passage 21. After the first intermediate passage 21, the fluid will continue onward to the selectable valve spool 13 and across the selectable valve spool notches 29 into the second intermediate passage 22. From the second intermediate passage 22, the fluid flows by the compensator piston 17 at undercut 34 and into the loop passage 23, where the selectable valve spool 13 directs fluid through a passage into the powered work port 26.

At all times during fluid flow, the compensator piston 17 ends 30, 31 are adapted to sense pressure, such as power passageway 20 pressure on end 31 through a sensing compensator passage internally. Power passage pressure on end 31 is measured internally through the compensator 17 and reduced pressure on end 30 is measure internally through the compensator 17 from the artificial pressure passage 25. By balancing the pressure on the compensator piston end 31 with the pressure on the compensator end 30 and the biasing spring 16, fine metering may be provided for the selectable valve spool 13 and control notches 29.

Returning fluid from the working function enters the work port 27, enters the body passage 27, and flows across the control notches to the return passage 24. Reversing the position of the selectable valve spool 13 to the second side of the housing (i.e. to the left side as shown in the figures) reverses the flows inside the valve powering the opposite work port 27 and returning to the opposite work port 26.

### C. Post-Compensated Configuration.

FIGS. 2, 4, and 6 illustrate different embodiments of the present invention configured for post-compensation. FIG. 1 illustrates the post-compensation configuration. FIG. 3 illustrates post pre-compensation configuration in a work position. FIG. 6 illustrates an alternate embodiment of the post-compensation configuration in which the compensator is positioned perpendicular with respect to the main control unit.

As shown in FIGS. 2 and 4, the post-compensated configuration 12 comprises a valve body 14 with a plurality of internal flow passageways 20, 21, 22, 23, 24, 26, 27. It should be noted that the number, configuration, orientation, and types of passageways 20, 21, 22, 23, 24, 26, 27 utilized may vary in different embodiments of the present invention. In the exemplary embodiment shown in the figures, these include a power passageway 20, a first intermediate passageway 21, a second intermediate passageway 22, a loop passage 23, one or more return passages 24, and a plurality of work ports 26, 27.

The post-compensated configuration 12 further comprises a selectable valve spool 13. Various types of spools may be utilized, and the types of spools shown in the figures should not be construed as limiting on the scope of the present invention. The selectable valve spool 13 may include a plurality of control notches 29. A post-compensator piston 18 is provided which may include metering notches 32. The spring 16 shown in the figures is generally biased to be normally closed in the post-compensated configuration 12.

When the selectable valve spool 13 is positioned toward a first side of the housing (i.e. to the right side as shown in the figures), fluid flows from the power passage 20, across the compensator piston 18 at undercut 35 and into the first intermediate passage 21. From there, the fluid flows onto the selectable valve spool 13 and across the selectable valve spool notches 29 into the second intermediate passage 22. From the second intermediate passage 22, the fluid flows by the compensator piston 18 and compensating aperture 32 into the loop passage 23, where the selectable valve spool 13 directs fluid into a passageway to the powered work port 26.

At all times during fluid flow, the compensator 18 piston ends 30, 31 sense multiple pressures. Power passage pressure on end 31 is measured internally through the compensator 18 and reduced pressure on end 30 is measure internally through the compensator 18 from the artificial pressure passage 25. By balancing the pressure on compensator 18 piston end 31 with the pressure on compensator 18 end 30 and the biasing spring 16, fine metering may be provided for the selectable valve spool 13 and control notches 29. Returning fluid from the working function enters work port 27, through an interconnected passageway 27, and flow across the control notches to the body return passage 24. Reversing the position of the selectable valve spool 13 toward the second side of the housing (i.e. to the left side as shown in the figures) reverses the flows inside the present invention powering the opposite work port 27 and returning to the opposite work port 26.

### D. Alternate Embodiments.

It should be appreciated that various aspects of the present invention may be altered in different embodiments of the present invention. For example, actuators may be utilized to control the sliding directional control component 13 of the modules. The actuators may be controlled in various manners, including electrically, hydraulically, pneumatically, or by computer logic to have the modules function in desired modes.

FIGS. 5 and 6 illustrate an alternate embodiment of both the pre-compensated configuration 11 and the post-compensated configuration 12. While FIGS. 1-4 illustrate an embodiment in which the compensator is parallel to the main control component, FIGS. 5-6 illustrate an embodiment in which the compensator is perpendicular to the main control component. In the latter embodiment, the compensator controls only one set of metering orifices and does not bypass any flow in the flow stream. The post-compensator controls the upstream metering orifices and the pre-compensator controls the downstream orifices. In such an embodiment, the compensator assemblies are still interchangeable for desired module functionality.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A control valve compensation system, comprising:
a valve body comprising a plurality of internal flow passageways and a plurality of work ports;
a selectable valve spool adjustably positioned within the valve body;
a pre-compensation assembly removably positioned within the valve body, wherein the valve body is adapted to function as a pre-compensated valve when the pre-compensation assembly is positioned with the valve body; and
a post-compensation assembly removably positioned within the valve body, wherein the valve body is adapted to function as a post-compensated valve when the post-compensation assembly is positioned with the valve body.

2. The control valve compensation system of claim 1, wherein the pre-compensation assembly is parallel with respect to the selectable valve spool when the pre-compensation assembly is positioned within the valve body.

3. The control valve compensation system of claim 2, wherein the post-compensation assembly is parallel with respect to the selectable valve spool when the post-compensation assembly is positioned within the valve body.

4. The control valve compensation system of claim 1, wherein the pre-compensation assembly is perpendicular with respect to the selectable valve spool when the pre-compensation assembly is positioned within the valve body.

5. The control valve compensation system of claim 4, wherein the post-compensation assembly is perpendicular with respect to the selectable valve spool when the post-compensation assembly is positioned within the valve body.

6. The control valve compensation system of claim 1, wherein the selectable valve spool comprises a plurality of control notches.

7. The control valve compensation system of claim 1, wherein the pre-compensation assembly comprises a pre-compensation piston.

8. The control valve compensation system of claim 7, wherein the pre-compensation piston comprises a pre-compensation aperture.

9. The control valve compensation system of claim 8, wherein the pre-compensation assembly comprises a pre-compensation spring.

10. The control valve compensation system of claim 9, wherein the pre-compensation spring is biased to be open absent application of force.

11. The control valve compensation system of claim 1, wherein the post-compensation assembly comprises a post-compensation piston.

12. The control valve compensation system of claim 11, wherein the post-compensation piston comprises a post-compensation aperture.

13. The control valve compensation system of claim 12, wherein the post-compensation assembly comprises a post-compensation spring.

14. The control valve compensation system of claim 13, wherein the post-compensation spring is biased to be closed absent application of force.

15. The control valve compensation system of claim 1, wherein adjustment of the selectable valve spool reverses flow of a fluid through the valve body.
